(19) United States
(12) Patent Application Publication
(10) Pub. No.: US 2026/0280239 A1
(43) Pub. Date: Sep. 17, 2026

(54) LOAD CENTER, NEUTRAL RAIL FOR LOAD CENTER, AND METHOD OF MAKING NEUTRAL RAIL

(71) Applicant: Schneider Electric USA, Inc., Boston, MA (US)

(72) Inventor: Hamid Abroy, Lexington, KY (US)

(21) Appl. No.: 19/081,738

(22) Filed: Mar. 17, 2025

(51) Int. Cl. H02B 1/20

(52) U.S. Cl. CPC H02B 1/20

(57) ABSTRACT

A load center for electrical distribution with a dielectric base has left and right neutral bus bars are at laterally spaced locations and left and right neutral rails connected to the bus bars. Each of the left and right neutral rails has a main rail section extending longitudinally along the dielectric base from a proximal end portion to a distal end portion and a connector section integrally formed with the respective main rail section and extending laterally from the proximal end portion of the main rail section. The left and right neutral rails are mounted on the dielectric base such that the main rail sections are spaced apart laterally and lie in a common neutral rail plane. The connector sections of the left neutral rail and the right neutral rail are offset from one another along the depth axis.

### FIELD

This disclosure generally pertains to a load center for electrical distribution, particularly, a plug-on neutral load center, and specifically to the plug-on neutral rails for such a load center and also to methods of making the neutral rails.

### BACKGROUND

Electrical load centers are configured to mount a plurality of circuit breakers to provide electrical power distribution to a building's branch circuits via the circuit breakers. Certain load centers utilize a “plug-on neutral” system, enabling direct connection of circuit breakers to a dedicated neutral rail. While simplifying installation for the end user, these load centers present manufacturing challenges. Current designs require numerous components to make the connection between the neutral from the main power source and the plug-on neutral rails.

### SUMMARY

In one aspect, a load center for electrical distribution comprises a dielectric base having a longitudinal axis, a lateral axis, and a front-to-back depth axis. Left and right neutral bus bars are supported on the dielectric base at spaced apart locations along the lateral axis. Each of the left and right neutral bus bars is configured to connect the load center to a main power source neutral. A left neutral rail is connected (e.g., electrically connected) to the left neutral bus bar, and a right neutral rail is connected (e.g., electrically connected) to the right neutral bus bar. Each of the left and right neutral rails comprise a main rail section extending longitudinally along the dielectric base from a proximal end portion to a distal end portion and a connector section integrally formed with the respective main rail section and extending laterally from the proximal end portion of the main rail section. The left and right neutral rails are mounted on the dielectric base such that the main rail sections are spaced apart laterally and lie in a common neutral rail plane. The connector sections of the left neutral rail and the right neutral rail are offset from one another along the depth axis.

In another aspect, a neutral rail is configured for selective use as either a left neutral rail or a right neutral rail in a load center for electrical distribution. The neutral rail comprises a main rail section having a main rail axis and a proximal end portion and a distal end portion spaced apart along the main rail axis. The main rail section is configured for making plug-on neutral connections with a plurality of circuit breakers at spaced apart locations along the main rail axis. A connector section is integrally formed with the main rail section and extending laterally from the proximal end portion of the main rail section along a connector section axis transverse to the main rail axis. The connector section has a first side and a second side parallel to the first side and spaced apart from the first side along a depth axis perpendicular to the connector section axis and the main rail axis. The first side and the second side are equidistant from the connector section axis and offset from the main rail axis by different dimensions along the depth axis. The neutral rail is configured to be selectively used as the left neutral rail by being installed in a dielectric base of the load center in a first orientation and to be selectively used as the right neutral rail by being installed in the dielectric base in a second orientation different from the first orientation.

In another aspect, a method of making a neutral rail configured for selective use as either a left neutral rail or a right neutral rail in a load center for electrical distribution comprises providing a piece of metal bar stock. An end section of the piece of metal bar stock is bent with respect to a main rail section of the piece of metal bar stock so the end section extends laterally outward with respect to a main rail section. The end section is coined to form a connector section having a connector section axis and opposite first and second sides equidistant from the connector section axis and offset from a main rail axis of the main rail section by different dimensions along a depth axis perpendicular to the connector section axis and the main rail axis.

Other aspects will be in part apparent and in part pointed out hereinafter.

### BRIEF DESCRIPTION OF THE DRAWINGS

FIG. 1 is a perspective of a load center of the present disclosure in an enclosure, which is illustrated schematically;

FIG. 2 is a perspective of the load center;

FIG. 3 is a front elevation of the load center;

FIG. 4 is a side elevation of the load center;

FIG. 5 includes a fragmentary cross section of the load center taken in the plane of line 5-5 of FIG. 3 and schematically illustrates a plug-on circuit breaker before it is plugged on a neutral rail of the load center;

FIG. 6 is a fragmentary cross section similar to FIG. 5 showing the circuit breaker plugged on the neutral rail;

FIG. 7 is a perspective showing a branch base separated from a mains base of the load center with left and right neutral rails already retained on the branch base;

FIG. 8 is a cross section taken in the plane of line 8-8 of FIG. 3;

FIG. 9 is a perspective of one of the neutral rails;

FIG. 10 is another perspective of the neutral rail;

FIG. 11 is an elevation of the neutral rail;

FIG. 12 is an elevation of the neutral rail in the opposite vantage from FIG. 11;

FIG. 13 is an elevation of the neutral rail in an orthogonal vantage from FIG. 11;

FIG. 14 is an elevation of the neutral rail in the opposite vantage from FIG. 13;

FIG. 15 is a bottom plan view of the neutral rail;

FIG. 16 is a top plan view of the neutral rail; and

FIG. 17 is a flow chart depicting a method of making the neutral rail.

Corresponding parts are given corresponding reference characters throughout the drawings.

### DETAILED DESCRIPTION

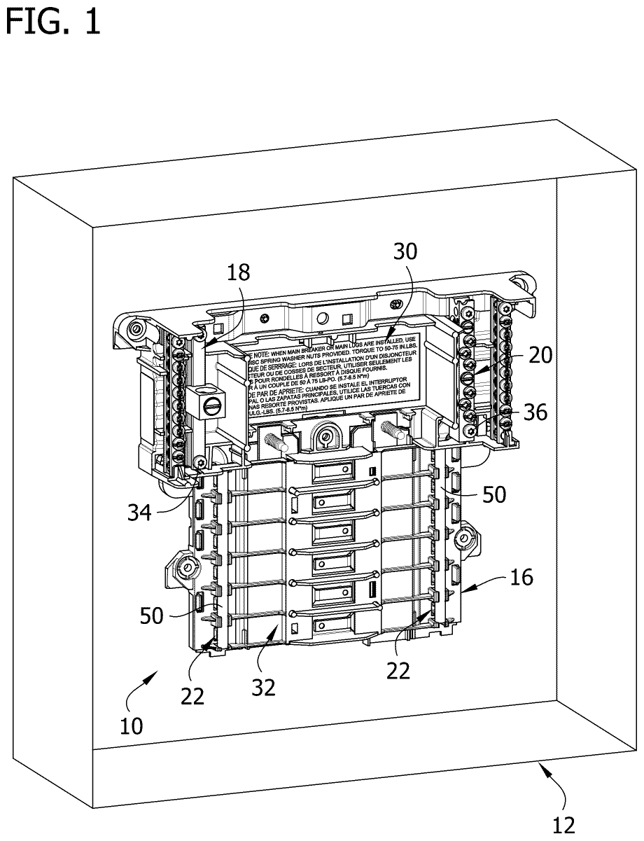

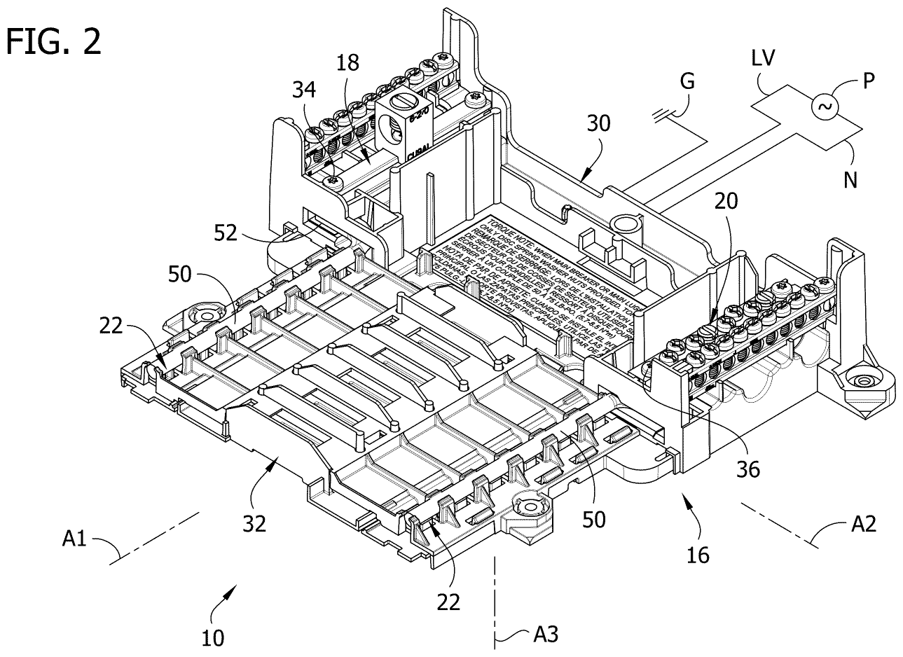

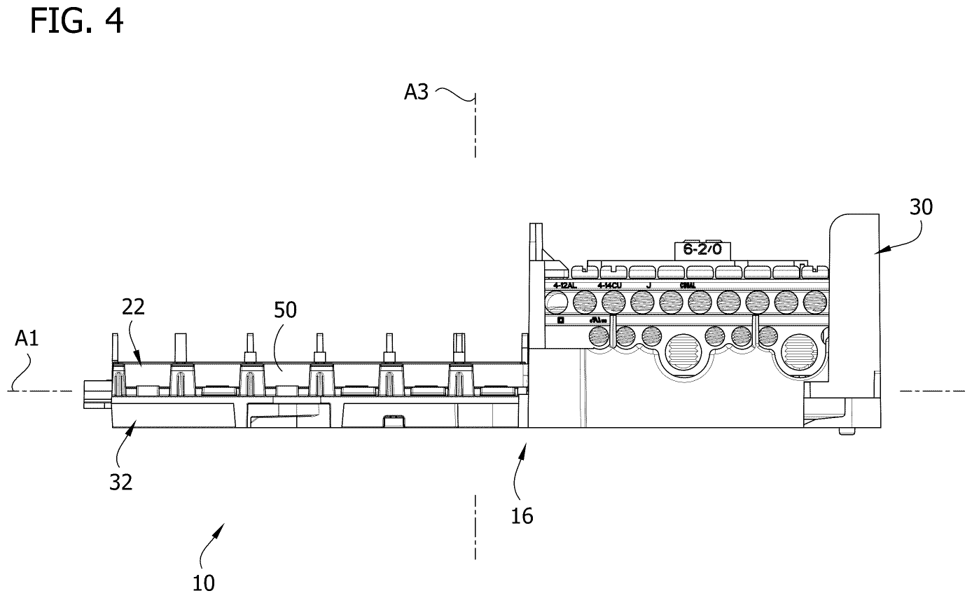

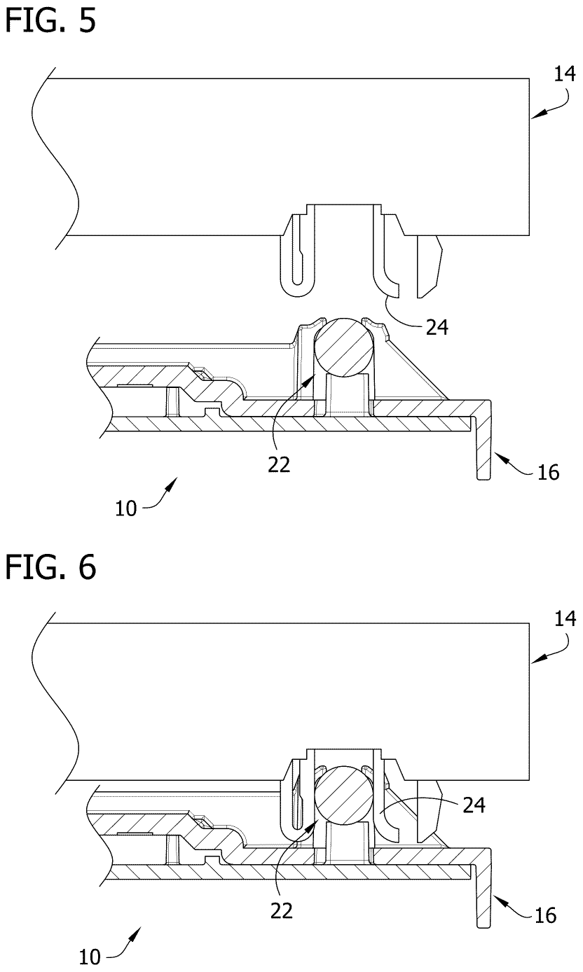

Referring to FIGS. 1-6, a load center for electrical distribution is generally indicated at reference number 10. In FIG. 1, the load center 10 is shown contained in a metal enclosure 12, which is illustrated schematically. As is known by those skilled in the art, the load center 10 is broadly configured to hold multiple circuit breakers 14 (shown schematically in FIGS. 5-6) that are connected to various branch circuits in an electrical distribution system. The load center 10 safely connects the circuit breakers 14 to a main power source P (FIG. 2). The load center 10 comprises a dielectric base 16 that supports various electrical components that connect the circuit breakers 14 to ground G, line voltage LV from the main power source P, and the main power source neutral N. This disclosure focuses on improvements related to the neutral components of the load center 10. The workings of other aspects of the load center 10 are well-understood by those skilled in the art and need not be further described here.

The illustrated load center 10 comprises a left neutral bus bar 18, a right neutral bus bar 20, and two neutral rails 22 (e.g., plug-on neutral rails). The neutral rails 22 are located at left and right positions on the dielectric base 16 for connecting, respectively, to the left and right neutral bus bars 18, 20. For example, the left neutral rail 22 is electrically connected to the left neutral bus bar 18 and the right neutral rail 22 is electrically connected to the right neutral bus bar 20. As will be explained in further detail below, the neutral rails 22 have substantially identical shapes but connect to the left and right neutral bus bars in asymmetrical fashion. This enables the neutral rails 22 to integrate with legacy load center layouts at both the left and right neutral rail positions. Moreover, the neutral rails 22 connect to the left and right neutral bus bars 18, 20 without intervening lugs, which eliminates two different parts that were previously required to connect two neutral rails to two neutral bus bars in asymmetrical fashion. Further only one screw 34, 36 is needed to connect each neutral rail 22 to the respective neutral bus bar 18, 22, whereas prior art load centers requiring neutral lugs utilized two screws at each neutral rail.

The illustrated load center 10 is a plug-on neutral load center. Those skilled in the art will understand that a plug-on neutral load center is configured to electrically connect to circuit breakers without pigtails. Instead, as shown in FIGS. 5-6, the circuit breakers 14 used in plug-on neutral load centers have neutral contact clips 24 that clip onto a neutral rail 22. The neutral contact clips 24 are configured automatically make an electrical connection between the circuit breaker 14 and the neutral rail 22 when the circuit breaker is plugged on a neutral rail. Although this disclosure uses the term “neutral rail,” to describe the parts 22 that electrically connect to the circuit breakers' neutrals, the same components also may correctly be called “neutral bars,” and hence, the terms “neutral rail” and “neutral bar” may be used interchangeably in this disclosure.

The dielectric base 16 has a length extending along a longitudinal axis A1, a width extending along a lateral axis A2, and front side and a back side spaced apart along a front-to-back depth axis A3. When the load center 10 is mounted in the enclosure 12, the back side faces the back wall of the enclosure and the front side faces the enclosure's doorway (which is shown open with the door removed in FIG. 1). The load center 10 is configured to mount the circuit breakers 14 on the front side of the dielectric base 16 in two columns, specifically, a left column, which defines a set of left breaker positions spaced apart along the longitudinal axis A1, and a right column, which defines a set of right breaker positions spaced apart along the longitudinal axis A1. As is common in the art, the illustrated load center 10 is arranged so that the left and right columns are spaced apart along the lateral axis A2 and each left breaker position is aligned with a corresponding right breaker position along the longitudinal axis A1.

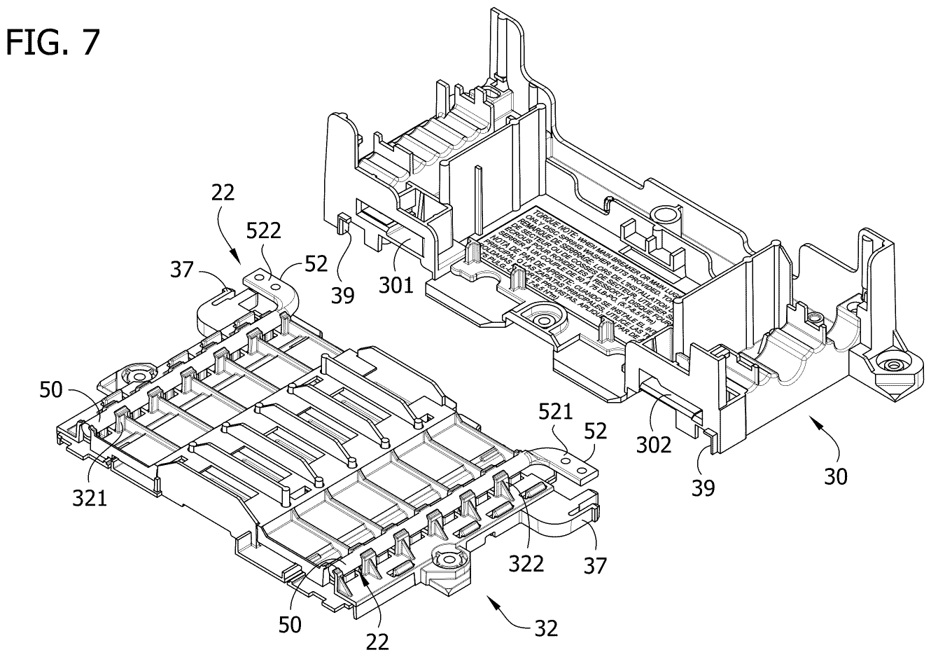

Referring to FIG. 7, the illustrated dielectric base 16 has two primary elements that are formed separately and attached together during assembly. First, a mains base element 30 is configured to support the left and right neutral bus bars 18, 20 (not shown in FIG. 7, but see FIGS. 1 and 2, for example) and other electrical components that connect the load center 10 to the main power source P. Second, a branch base element 32 is configured to support the circuit breakers 14 (not shown in FIG. 7, but see FIGS. 5-6) during use, along with the load center electrical components that interface with the circuit breakers 14, including the neutral rails 22. In the illustrated embodiment, the mains base element 30 is formed from a single piece of injection molded plastic and the branch base element 32 is formed from two separately formed pieces of injection molded plastic that are fitted together. Other load centers can have dielectric bases constructed in other ways without departing from the scope of the disclosure.

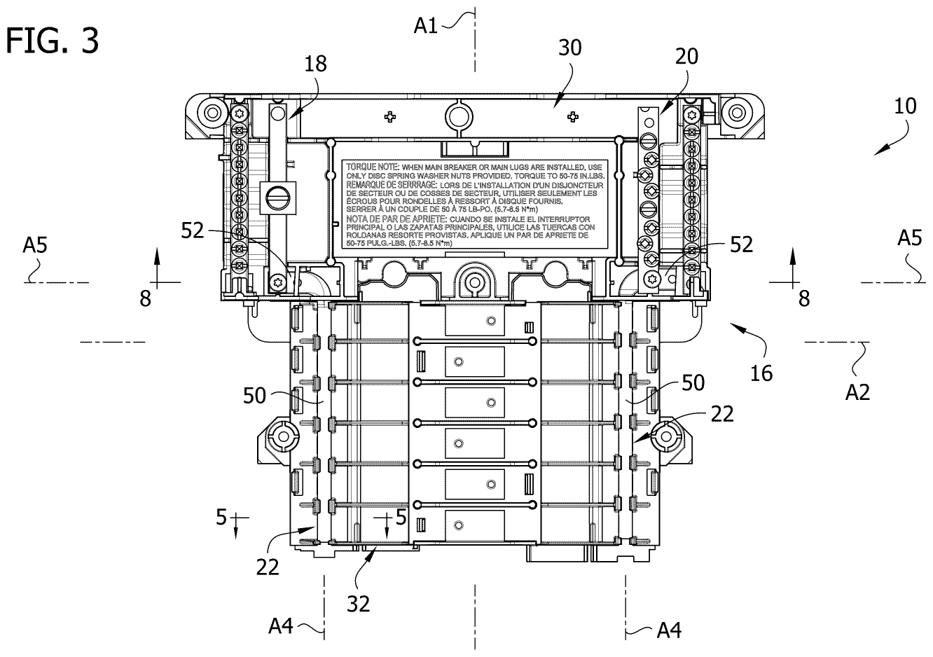

This disclosure frequently uses the terms left and right to refer to the relative positions of various features along the lateral axis A2. Occasionally, this disclosure also uses terms like upper and lower to refer to the relative positions of features along the longitudinal axis A1. Throughout this disclosure, the intended frame of reference for understanding these terms of direction is the orientation depicted in FIGS. 1 and 3, where the load center 10 is viewed from the front, the longitudinal axis A1 extends vertically, and the mains base element 30 is located above the branch base element 32. Those skilled in the art will recognize that this is the typical orientation in which load centers are viewed when installed in the field. Hence, in the frame of reference used for purposes of explanation in this disclosure, the mains base element 30 could be called the upper base element and the branch base element 32 could be called the lower base element because the mains base element is located above the branch base element in FIG. 1. Similarly, the left neutral bus bar 18 is called “left” because it is located to the left of the right neutral bus bar 20 in the orientation depicted in FIGS. 1 and 3. Relative positional terms such as left, right, upper, and lower are used in this disclosure for clarity of explanation and ease of understanding and should not be interpreted to impose any absolute requirements on the spatial positioning of the structures described herein. It will be understood that the orientations of load centers and their components may vary from what is shown during use without departing from the scope of the disclosure.

The branch base element 32 is configured to couple to the mains base element 30 to form the base 16. More specifically, the branch base element 32 is configured to be pressed into engagement with the mains base element 30 by movement relative to the mains base element along the longitudinal axis A1, whereby latches 37 on the branch base element 32 snap into recesses 39 on the mains base element to couple the two elements together.

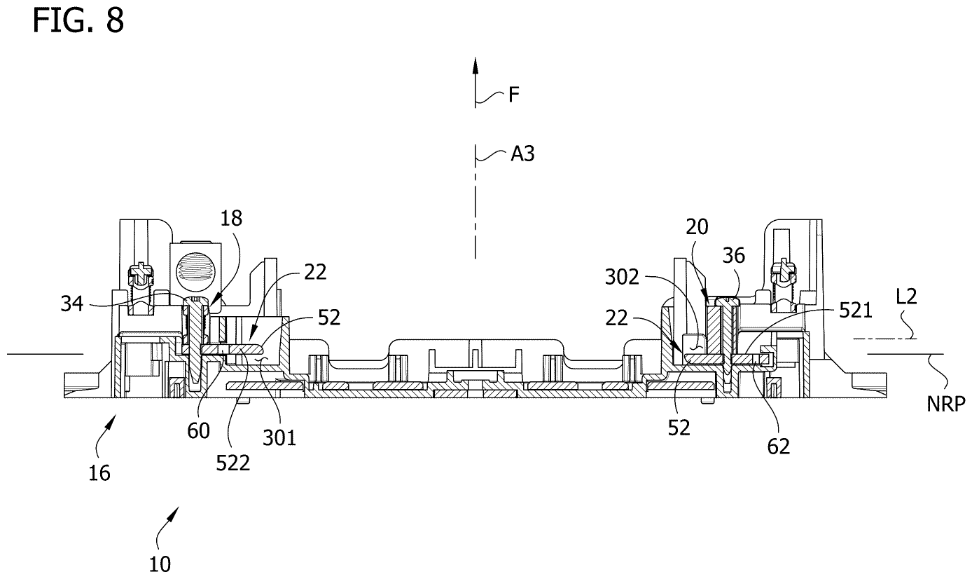

The mains base element 30 and the branch base element 32 are configured to operatively align the left and right neutral bus bars 18, 20 with the left and right neutral rails 22 so that the left and right neutral bus bars can be electrically connected (e.g., shorted) to the left and right neutral rails when the branch base element is coupled to the mains base element. The branch base element 32 comprises a left retainer 321 for retaining one neutral rail 22 (the left neutral rail) at a left rail position and a right retainer 322 for retaining another neutral rail (the right neutral rail) at a right rail position. When the left and right neutral rails 22 are retained in the left and right retainers 321, 322, as shown in FIG. 7, upper portions of left and right neutral rails protrude from the upper end portion of the branch base element 32. A lower end portion of the mains base element 30 defines a left receptacle 301 and a right receptacle 302. When the branch base element 32 is coupled to the mains base element 30, the protruding upper portion of the left neutral rail 22 is received in the left receptacle 40 and the protruding upper portion of the right neutral rail 22 is received in the right receptacle 42. As shown in FIG. 8, this positions the protruding portion of the left neutral rail 22 directly behind (along the depth axis A3) the lower end portion of the left neutral bus bar 18 and positions the protruding portion of the right neutral rail 22 directly behind (along the depth axis A3) the lower right neutral bus bar 20.

Referring again to FIG. 7, for reasons that will become apparent, the left receptacle 40 and the right receptacle 42 have different shapes. For instance, in the illustrated embodiment, the left receptacle 301 comprises a laterally elongate slot with a rearward protruding portion adjacent its laterally inboard end. By contrast, the right receptacle 302 comprises a laterally elongate slot with a forward protruding portion adjacent its laterally inboard end.

Referring to FIGS. 1-3, in the illustrated embodiment, the left and right neutral bus bars 18, 20 are the conventional neutral bus bars that have been used previously in Square D™ QO™ plug-on neutral load centers, available from the assignee of the present application.

Further, the illustrated left and right neutral bus bars 18, 20 are located, in relation to the overall layout of the load center 10, at essentially the same positions on the dielectric base 16 as the left and right neutral bus bars were located in Square D™ QO™ plug-on neutral load centers sold prior to the present disclosure. Upon inspection of a such a previously sold Square D™ QO™ plug-on neutral load center, the person skilled in the art would recognize that, two different lugs were used to connect the left and right neutral bus bars to the left and right left neutral rails. That is, a left lug having a first shape was used to connect the left neutral bus bar to the left neutral rail and a right lug having a second shape different from the first shape was used to connect the right neutral bus bar to the right neutral rail. In addition, two screws were needed to secure the neutral connections at each lug-one for connecting the lug to the respective neutral bus bar and another for connecting the lug to the respective neutral rail. As will be explained in further detail below, this disclosure provides an improved load center 10 that eliminates both lugs and reduces the number of screws used to connect each neutral bus bar 18, 20, to the respective neutral rail 22 from two screws to one screw 34, 36.

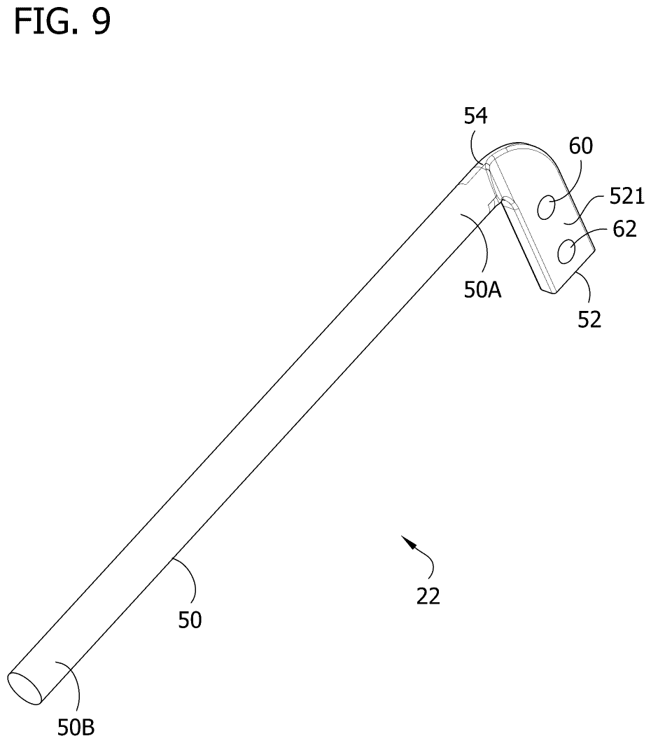

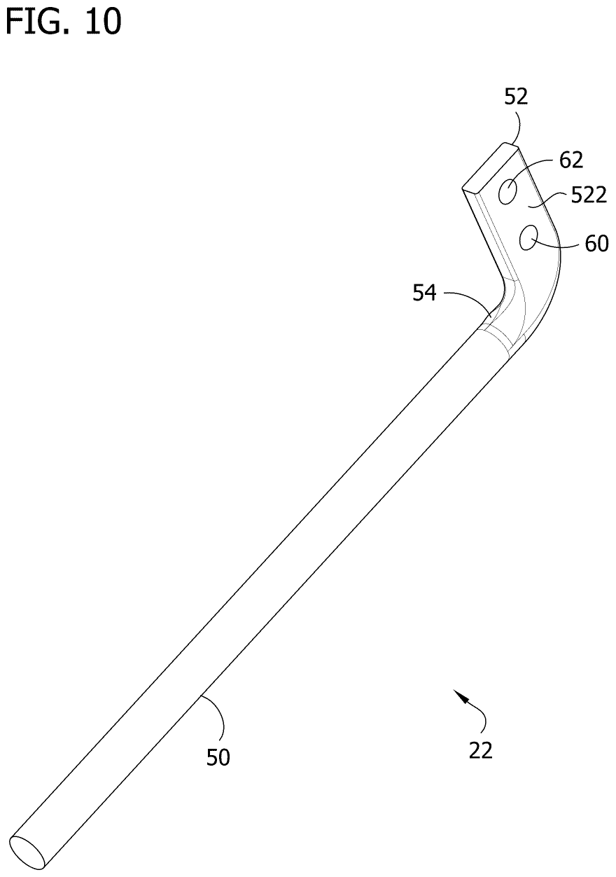

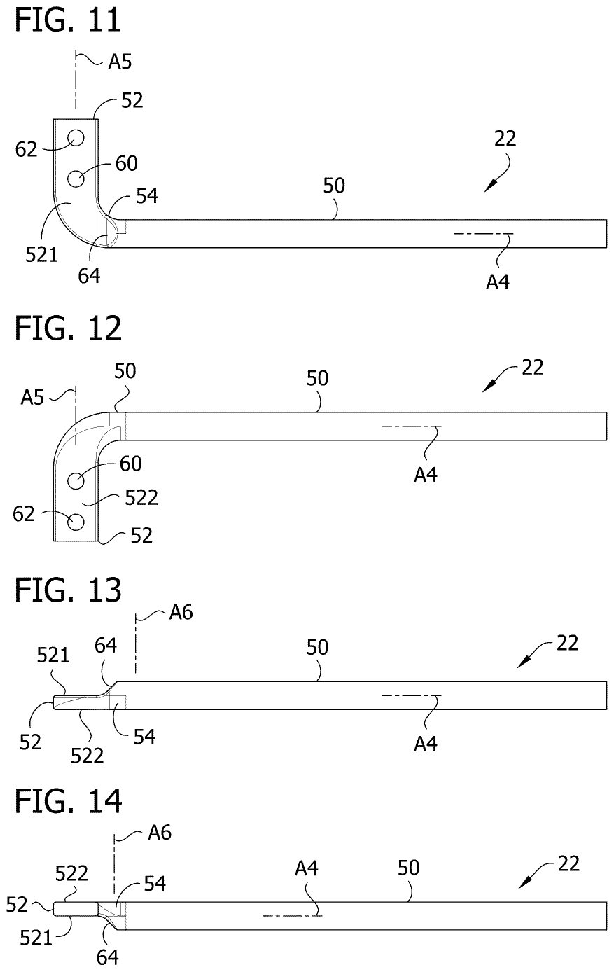

Referring to FIGS. 9-16, these objectives are attained by forming an asymmetrical neutral rail 22 that is configured to be positioned at either the left rail position or the right rail position for operative connection to the respective one of the left and right neutral bus bars 18, 20 using a single neutral connection screw 34, 36. As explained above, the left and right neutral rails 22 have substantially identical shapes. Here, “substantially identical shapes” means that that the left and right neutral rails 22 are capable of being formed in the same manufacturing process using the same tooling. Variance within acceptable manufacturing tolerances is permitted within the meaning of “substantially identical shapes.”

Each neutral rail 22 is substantially L-shaped (e.g., hockey stick-shaped). Each neutral rail 22 comprises a main rail section 50 and a connector section 52 integrally formed with the main rail section. That is, the neutral rail 22 comprises a main rail section 50 and a connector section 52 that are integrally formed from a single monolithic piece of conductive material (e.g., a single monolithic piece of metal bar stock). The connector section 52 extends laterally outward from one end portion of the main rail section 50 and is shorter than the main rail section. Generally, the main rail section 50 is configured to define the plug-on structure at which plug-on neutral circuit breakers 14 connect to the neutral rail. The connector section 52 is broadly configured to connect to either of the neutral bus bars 18, 20, depending on whether the neutral rail 22 is installed in the left rail position or the right rail position. As will be explained in further detail below, the main rail section 50 and the connector section 52 are centered at two different locations along the depth axis A3, which allows for asymmetrical connection to the left neutral bus bar 18 and the right neutral bus bar 20 and eliminates the need for two separate neutral lug parts for use on the left side and the right side of the load center 10.

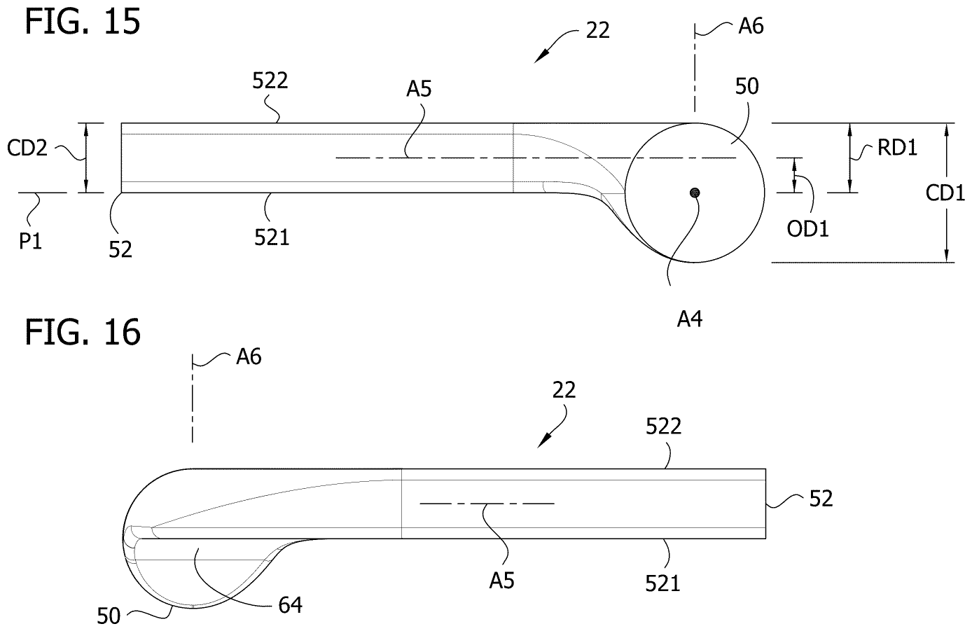

The main rail section 50 of each neutral rail 22 has a main rail axis A4 and extends longitudinally along the main rail axis from a proximal end portion 50A (FIG. 9) to a distal end portion 50B (FIG. 9). When each neutral rail 22 is installed in the dielectric base 16, the main rail section 50 extends longitudinally, e.g., the main rail axis A4 extends generally parallel to the longitudinal axis A1 as seen in FIG. 3. In general, the main rail section 50 is configured for making plug-on neutral connections with a plurality of circuit breakers 14 at spaced apart locations along the main rail axis A4. In the illustrated embodiment, the main rail section 50 of each of the neutral rail 22 is cylindrical. For example, the main rail section 50 has a circular cross-sectional shape centered on the main rail axis A4. As shown in FIG. 15, the main rail section 50 has a diameter or, more broadly, a cross-sectional dimension CD1 along a depth axis A6 of the neutral rail that extends parallel to the depth axis A3 of the dielectric base 16 of the load center 10 when the neutral rail is installed. In one or more embodiments, the cross-sectional dimension CD1 is in an inclusive range of from 0.24 inches to 0.26 inches. Although the illustrated main rail section 50 has a circular cross-sectional shape, other neutral rails could have main rail sections of other cross-sectional shapes (e.g., rectangular, notched, etc.) without departing from the scope of the disclosure.

The connector section 52 extends laterally outward from the proximal end portion 50A of the main rail section 50 along a connector section axis A5 transverse to the main rail axis A4. As shown in FIG. 3, when each neutral rail 22 is installed in the dielectric base 16, the connector section axis A5 extends generally parallel to the lateral axis A5. The connector section 52 of each neutral rail 22 has a flattened shape including a first side 521 and an opposite second side 522 spaced apart from the first side along the depth axis A6. In the illustrated embodiment, the neutral rail depth axis A6 is perpendicular to the main rail axis A4 and the connector section axis A5. The first and second sides 521, 522 are equidistant from the connector section axis A5. In one or more embodiments, the connector section 52 has a generally rectangular or obround cross-sectional shape. As shown in FIG. 15, the connector section 52 has a cross-sectional dimension CD2 along the depth axis A6 extending from the first side 521 to the second side 522. The cross-sectional dimension CD2 of the connector section 52 is less than the cross-sectional dimension CD1 of the main rail section 50. For example, in certain embodiments, the cross-sectional dimension CD2 is in an inclusive range of from 40% to 60% of the cross-sectional dimension CD1. In one or more embodiments, the cross-sectional dimension CD2 is in an inclusive range of from 0.115 inches to 0.135 inches.

Suitably, the connector section 52 of each neutral rail 22 has an inner opening 60 and an outer opening 62 outwardly spaced from the inner opening with respect to the main rail axis A4. As will be explained in further detail below, when two neutral rails 22 are installed in the load center, one at the left rail position and the other at the right rail position, one of the neutral connection screws 34 is installed in the inner opening of the respective neutral rail and the other neutral connection screw 36 is installed in the outer opening of the respective neutral rail. In one or more embodiments, when neutral rails 22 are installed in both the left neutral rail position and the right neutral rail position, the neutral rails are oriented so that both outer openings 62 are outwardly spaced from the inner opening 22 along the lateral axis A2. In other words, both the left and right neutral rails 22 are installed so that the respective connector sections 52 extend laterally outward.

Each neutral rail 22 further comprises a transition zone 54 between the main rail section 50 and the connector section 52. The transition zone 54 includes a ramp surface 64 skewed in relation to the axes A4, A5 such that the ramp surface blends the first side 521 of the connector section 52 with a perimeter surface of the main rail section 50 that is offset from the first side along the depth axis A6.

As mentioned above, the connector section axis A5 of each of the left and right neutral rails is offset from the respect main rail axis A4 along the depth axis A6 by an offset distance OD1. In certain embodiments, the offset distance OD1 is in an inclusive range of from 0.0525 inches to 0.0725 inches. The connector section 52 is offset depthwise in relation to the main rail section 50 such that first side 521 of the connector section is located closer to main rail axis A4 than the second side 522. For example, in one or more embodiments, the first side 521 extends generally in a first side plane P1, and the main rail axis A4 lies substantially in the first side plane. In the illustrated embodiment, the second side 522 of each neutral rail 22 is offset from the main rail axis A4 along the depth axis A6 by a radial dimension RD1 substantially equal to the one-half the cross-sectional dimension CD1.

Referring to FIGS. 7 and 8, the neutral rails 22 are shaped and arranged so that, when (i) the left neutral rail is retained on the left retainer 321 of the branch base element 32, (ii) the right neutral rail is retained on the right retainer 322 of the branch base element, and (iii) the branch base element is coupled to the mains base element 30, the connector section 52 of the left neutral rail is received in the left receptacle 301 and the connector section of the right neutral rail is received in the right receptacle 302. In this position, when neutral rails 22 are installed in the load center 10 at the left rail position and the right rail position, both connector sections 52 extend laterally outward from the proximal end portions 50A of their respective main rail sections 50. Hence, the first side 521 of the right neutral rail 22 faces forward (arrow F in FIG. 8) and the second side 522 of the left neutral rail faces forward. This means that the connector section 52 of the left neutral rail 22 is located somewhat forward (along the depth axis A3) of the connector section of the right neutral rail. By contrast, the left and right neutral rails 22 are mounted on the dielectric base 16 so that the main rail sections 50 are spaced apart laterally and lie in a common neutral rail plane NRP (e.g., the main rail axes A4 of both the left and right neutral rails 22 lie substantially on the common neutral rail plane NRP). In one or more embodiments, the common neutral rail plane NRP is generally parallel to the longitudinal axis A1 and lateral axis A2 of the dielectric base 16 (e.g., parallel to a back wall of the enclosure 12). In one or more embodiments, the connector sections 52 of the left neutral rail and the right neutral rail are offset from one another along the depth axis A3 such that the connector section axis A5 of the left neutral rail 22 is parallel to the connector section axis A6 of the right neutral rail and spaced apart from the connector section axis A6 in the forward direction F along the depth axis A3 by an offset in an inclusive range of from 0.050 inches to 0.15 inches, such as an offset of from 0.11 inches to 0.14 inches or 0.115 inches to 0.135 inches.

To make an electrical connection between the left neutral bus bar 18 and the left neutral rail 22, the left connection screw 34 is inserted through a clearance hole in the left neutral bus bar and threaded into the outer opening 62 in the connector section 52. In certain embodiments, the left connection screw 34 is a self-tapping screw that self-taps into the connector section 52 at the outer opening 62. Conversely, to make an electrical connection between the right neutral bus bar 20 and the right neutral rail 22, the right connection screw 36 is inserted through a clearance hole in the right neutral bus bar and threaded into the inner opening 60 in the connector section 52. In certain embodiments, the right connection screw 36 is a self-tapping screw that self-taps into the connector section 52 at the inner opening 60. It can be seen that only one screw 34, 36 is required to short each neutral rail 22 to the respective neutral bus bar 18. The load center 10 is free of any lugs between the left neutral rail 22 and the left neutral bus bar 18, and likewise, the load center is free of any lugs between the right neutral rail 22 and the right neutral bus bar 20.

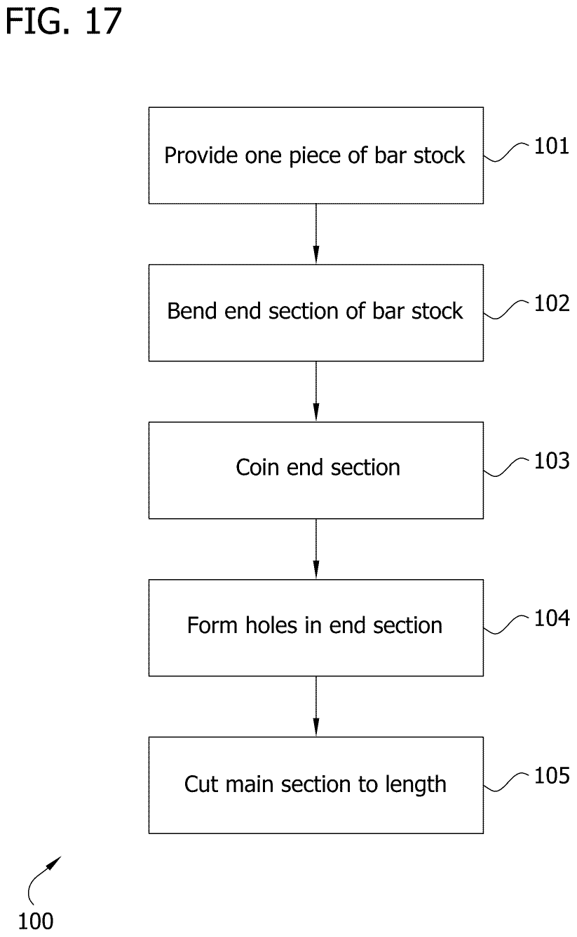

In an example embodiment, each neutral rail 22 is formed from a single piece of metal (e.g., conductive metal such as aluminum or copper) bar stock that is bent and then formed to have shape characteristics of the type described above. FIG. 17 depicts one suitable embodiment of a method of making a neutral rail 22 in accordance with the present disclosure, which is generally indicated at reference number 100. Initially, at a first step 101, a piece of metal bar stock is provided. At a second step 102, an end section of the piece of metal bar stock 102 is bent with respect to a main rail section 50 so that the end section extends laterally outward with respect to the main rail section (e.g., at about a right angle). Subsequently, at a third step 103, the end section is coined to form the end section to the shape of the connector section 52 of the neutral rail. For example, in this step 103, the end section is coined to define opposite first and second flat sides 521, 522 that are spaced apart along the depth axis A6 so that the opposite first and second sides are equidistant from the connector section axis A5 of the connector section but offset from the main rail axis A4 of the main rail section 50 by different dimensions along the depth axis A6. The coining step 102 also forms the transition zone 54 to includes the ramp surface 64 that blends the first side 521 of the connector section 52 with the perimeter surface of the main rail section 50. After coining, in steps 104 and 105, the inner and outer openings 60, 62 are formed (e.g., drilled) in the connector section 52 and the main rail section 50 is cut to length. It will be understood that the FIGS. 1-16 depict but one possible length for the neutral rails 22 and that the length of the neutral rails will vary in accordance with the circuit breaker capacity of the load center 10.

As can be seen, this disclosure provides a load center 10 that incorporates two substantially identical, one-piece plug-on neutral rails 22 shaped to facilitate connection to left and right neutral bus bars 18, 20 located at conventional positions using only one screw for each neutral rail. The same neutral bar 22, with its asymmetrical shape, is configured to be selectively used as a left neutral rail by being installed in the dielectric base 16 at the left rail position in a first orientation and to be selectively used as a right neutral rail by being installed in the dielectric base at the right rail position in a second orientation different from the first orientation. The asymmetrical neutral rail 22 according to the present disclosure eliminates two different lug components and two screws from comparable load centers that were previously available, yielding substantial cost savings to the manufacturer. Moreover, reducing the number of screw connections between each neutral bus bar 18, 20 and each neutral rail 22 from one to two is thought to improve the reliability of the neutral connections in the load center.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A load center for electrical distribution, the load center comprising:
a dielectric base having a longitudinal axis, a lateral axis, and a front-to-back depth axis;
left and right neutral bus bars supported on the dielectric base at spaced apart locations along the lateral axis, each of the left and right neutral bus bars configured to connect the load center to a main power source neutral; and
a left neutral rail connected to the left neutral bus bar and a right neutral rail connected to the right neutral bus bar, each of the left and right neutral rails comprising a main rail section extending longitudinally along the dielectric base from a proximal end portion to a distal end portion and a connector section integrally formed with the respective main rail section and extending laterally from the proximal end portion of the main rail section, the left and right neutral rails being mounted on the dielectric base such that the main rail sections are spaced apart laterally and lie in a common neutral rail plane, the connector sections of the left neutral rail and the right neutral rail being offset from one another along the depth axis.

2. The load center of claim 1, wherein the left neutral rail and the right neutral rail have substantially identical shapes.

3. The load center of claim 2, wherein the main rail section of each of the left and right neutral rails has a main rail axis and wherein the connector section of each of the left and right neutral rails has a connector section axis.

4. The load center of claim 3, wherein the connector section axis of each of the left and right neutral rails is offset from the respective main rail axis along the depth axis.

5. The load center of claim 3, wherein the main rail section of each of the left and right neutral rails is cylindrical.

6. The load center of claim 3, wherein the connector section of each of the left and right neutral rails has a flattened shape including a first side and an opposite second side spaced apart from the first side along the depth axis, the first and second sides being equidistant from the connector section axis.

7. The load center of claim 6, wherein each of the left and right neutral rails further comprises a transition zone between the main rail section and the connector section, wherein the transition zone includes a ramp surface skewed such that the ramp surface blends the first side with a surface of the main rail section offset from the first side along the depth axis.

8. The load center of claim 6, wherein the main rail section of each of the left and right neutral rails has a cross-sectional dimension along the depth axis and wherein the second side of each of the left and right neutral rails is offset from the main rail axis along the depth axis by a radial dimension substantially equal to the one-half the cross-sectional dimension.

9. The load center of claim 6, wherein the first side extends generally in a first side plane and wherein the main rail axis lies substantially in the first side plane.

10. The load center of claim 6, wherein the first side of each of the left and right neutral rails is located closer to the respective main rail axis than the second side.

11. The load center of claim 6, wherein the first side of the right neutral rail faces forward and the second side of the left neutral rail faces forward.

12. The load center of claim 2, wherein each of the left and right neutral rails is substantially L-shaped.

13. The load center of claim 2, wherein the connector section of each of the left and right neutral rails has an inner opening and an outer opening outwardly spaced from the inner opening along the lateral axis.

14. The load center of claim 13, further comprising a left connection screw connecting the left neutral bus bar to the left neutral rail and a right connection screw connecting the right neutral bus bar to the right neutral rail, wherein each of the left and right connection screws is threaded into either the inner opening or the outer opening of the respective connector section and wherein one of the left and right connection screws is threaded into the respective inner opening and the other of the left and right connection screws is threaded into the respective outer opening.

15. The load center of claim 14, wherein the left connection screw is threaded into the outer opening of the connector section of the left neutral rail and wherein the right connection screw is threaded into the inner opening of the connector section of the right neutral rail.

16. The load center of claim 1, wherein the load center is free of any lugs between the left neutral rail and the left neutral bus bar and wherein the load center is free of any lugs between the right neutral rail and the right neutral bus bar.

17. The load center of claim 1,
wherein the dielectric base comprises a mains base element and a branch base element configured to couple to the mains base element,
wherein the branch base element comprises a left retainer for retaining the main rail section of the left neutral rail on the branch base element and a right retainer for retaining the main rail section of the right neutral rail on the branch base element,
wherein the mains base element comprises a left receptacle and a right receptacle, and
and wherein the left and right neutral rails are shaped and arranged so that, when the left neutral rail is retained on the left retainer of the branch base element, the right neutral rail is retained on the right retainer of the branch base element, and the branch base element is coupled to the mains base element, the connector section of the left neutral rail is received in the left receptacle and the connector section of the right neutral rail is received in the right receptacle.

18. The load center of claim 17, wherein the left and right receptacles are different shapes.

19. A neutral rail configured for selective use as either a left neutral rail or a right neutral rail in a load center for electrical distribution, the neutral rail comprising:
a main rail section having a main rail axis and a proximal end portion and a distal end portion spaced apart along the main rail axis, the main rail section configured for making plug-on neutral connections with a plurality of circuit breakers at spaced apart locations along the main rail axis; and
a connector section integrally formed with the main rail section and extending laterally from the proximal end portion of the main rail section along a connector section axis transverse to the main rail axis, wherein the connector section has a first side and a second side parallel to the first side and spaced apart from the first side along a depth axis perpendicular to the connector section axis and the main rail axis, the first side and the second side being equidistant from the connector section axis and offset from the main rail axis by different dimensions along the depth axis,
wherein the neutral rail is configured to be selectively used as the left neutral rail by being installed in a dielectric base of the load center in a first orientation and to be selectively used as the right neutral rail by being installed in the dielectric base in a second orientation different from the first orientation.

20. A method of making a neutral rail configured for selective use as either a left neutral rail or a right neutral rail in a load center for electrical distribution, the method comprising:
providing a piece of metal bar stock;
bending an end section of the piece of metal bar stock with respect to a main rail section of the piece of metal bar stock so the end section extends laterally outward with respect to a main rail section; and
coining the end section to form a connector section having a connector section axis and opposite first and second sides equidistant from the connector section axis and offset from a main rail axis of the main rail section by different dimensions along a depth axis perpendicular to the connector section axis and the main rail axis.
